(19) United States
(12) Patent Application Publication
(10) Pub. No.: US 2010/0173104 A1
(43) Pub. Date: Jul. 8, 2010

(54) MANUFACTURING METHOD OF RECORDING MEDIUM, INKJET RECORDING MEDIUM, AND METHOD OF MANUFACTURING THE SAME

(75) Inventor: Tomoya Kubota, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/294,928

(22) PCT Filed: Mar. 20, 2007
(86) PCT No.: PCT/JP2007/056517

§ 371 Date: Sep. 28, 2008

(30) Foreign Application Priority Data
Mar. 30, 2006 (JP) 2006-095292

(51) Int. Cl. B41M 5/52; B05D 3/04

(52) U.S. Cl. 428/32.26; 427/341

(57) ABSTRACT

The manufacturing method of a recording medium of the invention includes forming an ink-receiving layer by applying an ink-receiving layer coating solution containing at least a water-soluble resin and a crosslinking agent on a support, and performing alkali treatment on the coating layer surface by using a basic gas, during drying of the coating layer after forming the coating layer by applying the ink-receiving layer coating solution on the support. The inkjet recording medium of the invention is manufactured by this manufacturing method.

The disclosure of Japanese Patent Application No. 2006-95929 is incorporated herein by reference in its entirety.

### TECHNICAL FIELD

The invention relates to a manufacturing method of recording medium, a recording material suited to inkjet recording using water-based ink, oil-based ink, or solid ink which is solid at ordinary temperature, and is liquid when dissolved to be presented to printing of image, and more particularly to an inkjet recording medium excellent in ink-receiving performance and a method of manufacturing the same.

### RELATED ART

Along with rapid growth in information technology industry, recently, various information processing systems are developed, and recording methods and devices suited to such information systems are developed and put in use.

Among above-described recording methods, the inkjet recording method is widely employed in both office and household use because of its advantages such as capability of recording in various recording materials, relatively low cost of the hardware (apparatus), compact design, and silent operation.

Further, as the inkjet printer is advanced with respect to resolution, recorded matter of photograph-like high image quality can be obtained. Further, by advancement of hardware (apparatus), various types of recording medium for inkjet recording are developed. Moreover, as application for photo glossy paper used for the purpose of obtaining recorded matter of photograph-like high image quality, in addition to the above characteristics, glossiness, surface smoothness, and printing paper touch similar to silver salt photograph are demanded.

As inkjet recording sheet satisfying these demands, various materials have been proposed, such as color material receiving layer formed by applying a solution containing inorganic fine particles, mordant, water-soluble resin such as PVA, and hardening agent of water-soluble resin, on a support (see, for example, patent document 1: Japanese Patent Application Laid-Open (JP-A) No. 2000-211235, paragraphs 0005 to 0057), and color material receiving layer formed by applying a solution containing inorganic fine particles, metal compound, water-soluble resin such as PVA, on a support, and further applying a solution containing hardener of water-soluble resin on the applied layer before the applied layer is dried completely (see, for example, patent document 2: JP-A No. 2001-334742).

The color material receiving layer of inkjet recording sheet in patent document 1 is obtained by applying and drying a coating solution containing vapor phase silica, cationic polymer having constituent unit of polydiarylamine derivative (dimethyl diaryl ammonium chloride polymer), PVA and boric acid, but this inkjet recording sheet has been desired to be improved in print density of image and glossiness.

In the ink-receiving layer (color material receiving layer) of inkjet recording sheet in patent document 2, the ink-receiving layer is a layer obtained by applying a coating solution containing inorganic fine particles (for example, vapor phase silica of which average primary particle diameter is 20 nm or less), water-soluble resin (for example, PVA), and dihydric or higher water-soluble metal salt, on a support, and further applying a solution containing a crosslinking agent (for example, borax or boric acid) capable of crosslinking the water-soluble resin, simultaneously with application or before the applied layer comes to show falling drying rate, and curing, and the obtained ink-receiving layer is capable of preventing cracks, but it has been desired to be improved in print density of image and glossiness.

The mordant for fixing the dye in the ink-receiving layer is not limited to the cationic polymer disclosed in patent document 1, but includes inorganic mordants such as polyhydric metal salts (see for example, patent documents 3 to 5). Patent document 3 is JP-A No. 2002-172850, patent document 4 is JP-A No. 2002-192830, and patent document 5 is JP-A 2002-274013.

When an ink-receiving layer is formed in the procedure of patent document 2 by using inorganic mordant disclosed in patent document 3 to 5, although the ink-receiving layer was not cracked, the glossiness is desired to be improved.

### DISCLOSURE OF INVENTION

The invention is devised in consideration of the above matters. The invention is a manufacturing method of a recording medium, the method comprising drying a coating layer formed by applying a coating solution containing at least a water-soluble resin and a crosslinking agent, wherein the drying of coating layer includes performing alkali treatment on the coating layer surface by using a basic gas.

The above described object can be achieved by the following items <1> to <10>.

<1> A manufacturing method of a recording medium, the method comprising drying a coating layer formed by applying a coating solution containing at least a water-soluble resin and a crosslinking agent, wherein the drying of coating layer includes performing alkali treatment on the coating layer surface by using a basic gas.

<2> A manufacturing method of an inkjet recording medium, the method comprising: forming an ink-receiving layer by applying an ink-receiving layer coating solution containing at least a water-soluble resin and a crosslinking agent on a support; and performing alkali treatment on the coating layer surface by using a basic gas, during drying of the coating layer after forming the coating layer by applying the ink-receiving layer coating solution on the support.

<3> The manufacturing method of an inkjet recording medium of item <2>, wherein the basic gas is ammonia gas.

<4> The manufacturing method of an inkjet recording medium of item <2> or <3>, wherein the concentration of the basic gas during the drying is 3 ppm or more.

<5> The manufacturing method of an inkjet recording medium of any one of items <2> to <4>, wherein the alkali treatment by the basic gas is performed when the solid content concentration of the coating layer during the drying is 20 mass % or less, or while the coating layer is exhibiting a constant drying rate.

<6> The manufacturing method of an inkjet recording medium of any one of items <2> to <5>, wherein the ink-receiving layer coating solution further contains inorganic fine particles, and the inorganic fine particles are at least one selected from the group consisting of silica fine particles, colloidal silica, alumina fine particles, and puseudo-boehmite.

<7> The manufacturing method of an inkjet recording medium of any one of items <2> to <6>, wherein the water-soluble resin is a polyvinyl alcohol-based resin.

<8> The manufacturing method of an inkjet recording medium of any one of items <2> to <7>, wherein the crosslinking agent is a boron compound.

<9> The manufacturing method of an inkjet recording medium of any one of items <2> to <8>, wherein a basic solution of pH of 7.1 or more is applied on the coating layer after the alkali treatment and while the coating layer is exhibiting a constant drying rate.

<10> An inkjet recording medium manufactured by the manufacturing method of an inkjet recording medium of any one of items <2> to <9>.

Additionally, the invention is a manufacturing method of an inkjet recording medium, the method comprising:

forming an ink-receiving layer by applying an ink-receiving layer coating solution containing at least a water-soluble resin and a crosslinking agent on a support; and performing alkali treatment on the coating layer surface by using a basic gas, during drying of the coating layer after forming the coating layer by applying the ink-receiving layer coating solution on the support.

Additionally, the invention is an inkjet recording medium manufactured by this manufacturing method of inkjet recording medium.

### BEST MODE FOR CARRYING OUT THE INVENTION

### Manufacturing Method of Recording Medium

The manufacturing method of recording medium of the invention comprises a drying process of a coating layer formed by applying a coating solution containing at least a water-soluble resin and a crosslinking agent, wherein the drying process of coating layer includes a process of alkali treatment on the coating layer surface by using a basic gas.

By such alkali treatment on the coating layer surface by using a basic gas, the pH of coating layer surface is raised, and crosslinking of water-soluble resin and crosslinking agent is promoted only on the surface, and only the surface is gelled, and it is estimated that the glossiness (sense of gloss) is enhanced.

Examples of recording medium include recording medium for inkjet and recording medium for sublimation transfer, and examples of coating layer include image receiving layer for inkjet, back layer for inkjet, and binder layer for sublimation transfer.

<Manufacturing Method of Inkjet Recording Medium>

Manufacturing method of inkjet recording medium of the invention is a manufacturing method of an inkjet recording medium, the method comprising: forming an ink-receiving layer by applying an ink-receiving layer coating solution containing at least a water-soluble resin and a crosslinking agent on a support; and performing alkali treatment on the coating layer surface by using a basic gas, during drying of the coating layer after forming the coating layer by applying the ink-receiving layer coating solution on the support.

In the invention, at process of drying the coating layer formed by applying the ink-receiving layer coating solution, the coating layer is subjected to an alkali treatment by using a basic gas. It is conjectured that, by alkali treatment of the coating layer by the basic gas, the pH of the coating layer surface is elevated, the crosslinking reaction of the water-soluble resin and the crosslinking agent is promoted only on the surface, and only the surface is gelled, whereby a high glossiness (sense of gloss) is achieved.

The manufacturing method of ink jet recording medium of the invention is described below.

<Ink-Receiving Layer Coating Solution>

The ink-receiving layer coating solution of the invention contains at least water-soluble resin and crosslinking agent, and preferably contains inorganic fine particles, and may also contain mordant and various additives.

A specific example of the ink-receiving layer coating solution is an ink-receiving layer coating solution containing vapor phase silica, polyvinyl alcohol (PVA), boric acid, cationic resin, a nonionic or amphoteric surface active agent, and an organic solvent having a high boiling point, which may be prepared by the following procedure. Components of the ink-receiving layer coating solution are specifically described later.

Vapor phase silica is added in water, cationic resin is further added, and dispersion is carried out by using a high pressure homogenizer or sand mill. Thereafter, boric acid is added, a PVA aqueous solution (for example, PVA added to about ⅓ by mass of vapor phase silica) is added, a nonionic or amphoteric surface active agent and an organic solvent having a high boiling point are further added, and stirring is carried out. The obtained coating solution is a uniform sol, and it is applied on the support by the following coating method, whereby a coating layer is obtained, and a porous ink-receiving layer having a three-dimensional reticular structure is formed. At this time, by adding the PVA after diluting the boric acid as described above, partial gelation of the PVA can be prevented.

When the ink-receiving layer coating solution is pulverized by a dispersing machine, a water dispersing solution containing particles having an average particle diameter of 10 to 300 nm is obtained. The dispersing machine for obtaining the water dispersing solution includes high speed rotating dispersing machine, medium stirring type dispersing machine (ball mill, sand mill, etc.), ultrasonic dispersing machine, colloid mill dispersing machine, high pressure dispersing machine, and other known dispersing machines, and the medium stirring type dispersing machine, colloid mill dispersing machine and high pressure dispersing machine are particularly preferred from the viewpoint of efficient dispersion of formed lumps of fine particles.

In the invention, the ink-receiving layer coating solution is preferred to be an acidic solution, and the pH of ink-receiving layer coating solution is preferred to be 6.0 or less, more preferably 5.0 or less, or particularly preferably 4.0 or less. The value of pH can be adjusted by properly selecting the type or adding amount of cationic resin. It may be also adjusted by adding organic or inorganic acid. When the pH of ink-receiving layer coating solution is 6.0 or less, crosslinking reaction of water-soluble resin by crosslinking agent (especially boron compound) in the ink-receiving layer coating solution can be suppressed sufficiently.

To apply the ink-receiving layer coating solution, various known application tools may be used, such as extrusion die coater, air doctor coater, blade coater, rod coater, knife coater, squeeze coater, reverse roll coater, and bar coater.

<Drying>

After application of ink-receiving layer coating solution, in the drying process, the obtained coating layer is dried. At the drying process, the temperature is 30 to 150° C. (preferably 50 to 120° C.), and the duration is 5 to 30 minutes (preferably 10 to 20 minutes), and the coating layer is dried. This drying time varies according to the amount of application, but is usually enough in this range. Drying means includes hot air dryer, infrared irradiation, and others.

At the drying process of the invention, alkali treatment is applied to the coating layer by using a basic gas. Alkali treatment means contacting of coating layer surface with basic gas, and only the vicinity of the surface can be gelled by promoting crosslinking reaction of water-soluble resin and crosslinking agent only near the surface. The basic gas to be used in alkali treatment includes ammonia gas, dimethylamine, trimethylamine, pyridine, and other water-soluble amine.

Concentration of basic gas in alkali treatment is preferably 3 ppm or more, or more preferably 6 ppm or more. The upper limit is not particularly limited, but it is about 30 ppm.

By concentration control of basic gas, the glossiness can be varied freely. That is, the glossiness is increased when the concentration of basic gas is higher, and the glossiness is decreased when the concentration is lower.

The concentration of basic gas in alkali treatment is the concentration in the closed space at the drying process, that is, the concentration in the drying zone.

From the viewpoint of obtaining high glossiness by gelling only the surface of the coating layer, the alkali treatment is preferred to be executed while the solid content concentration of coating layer is 20 mass % or less or while the coating layer shows a constant drying rate.

The state of the solid content concentration in the coating layer being 20 mass % or less can be calculated from the ratio by weight immediately after application, but cutting out a specified amount from the support.

The period showing a constant drying rate is before the coating layer shows falling drying rate, and is usually a process of several minutes from immediately after application of ink-receiving layer coating solution, and it shows a phenomenon of constant drying of decrease of content of solvent (dispersion medium) in the coating layer in proportion to the time in this period. The time indicating the constant drying is explained, for example, in Chemical Engineering Handbook (pp. 707-712, Maruzen Co., Ltd., Oct. 25, 1980).

In the invention, it is preferred to add a basic solution of pH 7.1 or more to the coating layer after alkali treatment. The basic solution is also preferred to be applied while a constant drying rate is shown.

The basic solution may contain, as required, crosslinking agent and other mordant components. The basic solution is used as alkaline solution, and promotes to harden the film, and the pH is adjusted to 7.1 or more, preferably pH 7.5 or more, or more preferably pH 7.9 or more. If the pH value is too close to the acidic side, crosslinking reaction of water-soluble polymer contained in the basic solution by crosslinking agent is not performed sufficiently, bronzing, cracks in ink-receiving layer or other defects may occur.

The basic solution is prepared, for example, by using ion exchange water, and adding metal compound (for example, 1 to 5%) and basic compound (for example, 1 to 5%), and, as required, paratoluene sulfonic acid (for example, 0.5 to 3%), and stirring sufficiently. The content (%) of the components indicates the solid content mass %.

The solvent used in preparation of ink-receiving layer coating solution and basic solution includes water, organic solvent, or their mixed solution. The organic solvent usable in application includes alcohols such as methanol, ethanol, n-propanol, i-propanol, and methoxy propanol, ketones such as acetone, methyl ethyl ketone, and tetrahydrofurane, acetonitrile, ethyl acetate, toluene, and the like.

Methods of applying a basic solution to the coating layer include (1) a method of applying a basic solution further on the coating layer, (2) a method of applying by spraying or other method, and (3) a method of immersing the support having the coating layer formed in the basic solution.

In the method of (1), the method of applying the basic solution is realized by using various known application tools, such as curtain flow coater, extrusion die coater, air doctor coater, blade coater, rod coater, knife coater, squeeze coater, reverse roll coater, and bar coater. In particular, it is preferred to employ a method not allowing direct contact of coater with the already formed coating layer, such as extrusion die coater, curtain flow coater, and bar coater.

After addition of basic solution, generally, the solution is heated for 0.5 to 30 minutes at 40 to 180° C., and is dried and cured. It is more preferred to heat for 1 to 20 minutes at 40 to 150° C.

After the ink-receiving layer is formed on the support, the ink-receiving layer is calendered by being passed between a roll nip under heat and pressure by using a super calender, gloss calender, or the like, whereby the surface smoothness, glossiness, transparency, and coating film strength can be enhanced. However, since the calendering may decrease the void ratio (that is, the ink absorbing property may be lowered), it is therefore necessary to set conditions such that the decrease in the void ratio is small.

In the calendering process, the roll temperature is preferably 30 to 150° C., or more preferably 40 to 100° C. The linear pressure between rolls in calendering process is preferably 50 to 400 kg/cm, or more preferably 100 to 200 kg/cm.

Layer thickness of the ink-receiving layer is required to have absorption capacity enough to absorb all liquid droplets in the case of inkjet recording, and must be determined in relation to the voids in the layer. For example, in the case of ink volume of 8 nL/mm² and voids of 60%, the layer thickness of about 15 μm or more is needed. In the case of inkjet recording, a desired thickness of ink-receiving layer is 10 to 50 μm.

Pore size of the ink-receiving layer is preferred to be 0.005 to 0.30 μm in median diameter, more preferably 0.01 to 0.025 μm.

Voids and pore median diameter can be measured by using mercury porosimeter (trade name: Pore Sizer 9320-PC2, manufactured by Shimadzu Corporation).

Preferably, the ink-receiving layer is excellent in transparency, and specifically its haze value is preferred to be 30% or less when the ink-receiving layer is formed on a transparent film, or more preferably 20% or less. The haze value can be measured by haze meter (HGM-2DP, manufactured by Suga Testing Machine Co.).

Components for composing the ink-receiving layer coating solution and basic solution are described below in detail.

(Inorganic Fine Particles)

The ink-receiving layer coating solution is preferred to be composed by using inorganic fine particles. Examples of inorganic fine particles include silica fine particles such as vapor phase silica and hydrous silica fine particles, colloidal silica, alumina fine particles, puseudo-boehmite, titanium dioxide, barium sulfate, calcium silicate, zeolite, kaolinite, haloicyte, mica, talc, calcium carbonate, magnesium carbonate, calcium sulfate, and baimite. They may be used either alone or in combination of two or more kinds. In the invention, among the inorganic fine particles, at least one type should be selected from the group consisting of silica fine particles, colloidal silica, alumina fine particles, and puseudo-boehmite. These inorganic fine particles are preferred to be used as being dispersed in cationic resin.

Among the inorganic fine particles, the vapor phase silica is particularly preferred, and the vapor phase silica and inorganic fine particles may be used in combination. When used in combination, the content of vapor phase silica in the total mass of inorganic fine particles is preferred to be 90 mass % or more, or more preferably 95 mass % or more.

Silica fine particles are roughly classified into wet process particles and dry process (vapor phase) particles by the manufacturing method. In wet process, generally, active silica is generated by acidolysis of silicate, and it is properly polymerized, agglutinated and sedimented, and silica containing water is obtained. In vapor phase process, generally, anhydrous silica is obtained by a method of high temperature vapor phase hydrolysis of silicon halide (flame hydrolysis method), or a method of heating, reducing and vaporizing silica sand and coke in electric furnace by arc, and oxidizing in air (arc method), and the vapor phase silica is anhydrous silica fine particles obtained by vapor phase method.

Vapor phase silica is different from hydrous silica, in density of surface silanol group, or presence or absence of pores, showing different properties, but is suited to forming of three-dimensional structure high in voids. The reason is not clear, but the hydrous silica is high in density of silanol groups on the fine granule surface, about 5 to 8 groups/nm², and silica fine particles are likely to aggregate, whereas the vapor phase silica is low in density of silanol groups on the fine granule surface, about 2 or 3 groups/nm², and coarse flocculates are formed, and the structure is estimated to be high in voids.

The vapor phase silica is particularly large in specific surface area, and is high in ink absorbing and holding efficiency, and is low in refractive index, and when dispersed to a proper particle diameter, the ink-receiving layer becomes transparent, and a high color density and favorable coloring property can be obtained. Transparency of receiving layer is important from the viewpoint of obtaining a high color density and favorable coloring gloss also when the ink is applied in photo glossy paper or the like.

Average primary particle diameter of vapor phase silica is preferably 20 nm or less, more preferably 10 nm or less, and most preferably 3 to 10 nm. In the vapor phase silica, since particles are likely to adhere to each other by hydrogen bond by silanol group, and when the average primary particle diameter is 20 nm or less, a structure of high voids (high void contents) can be formed, and the ink absorbing property can be effectively enhanced, and the transparency and surface glossiness of ink-receiving layer can be enhanced. The vapor phase silica may be formed of primary particles or may contain secondary particles.

Vapor phase silica is preferred to be used in dispersion state. Vapor phase silica can be dispersed by using cationic resin as dispersant (aggregation preventive agent), and vapor phase silica dispersing matter is formed. The cationic resin is not particularly limited, and includes mordants listed below, such as cation polymer having primary to tertiary amino groups and their salts, and quaternary ammonium base. Silane coupling may be also used as dispersant. Specifically, water-soluble or aqueous emulsion type may be used preferably, and examples include polycationic-based cationic resin such as dicyan-based cationic resin represented by dicyan diamide-formalin polycondensate, polyamine-based cationic resin represented by dicyan amide-diethylene triamine polycondensate, epichlorhydrine-dimethylamine addition polymer, dimethyl allyl ammonium chloride-SO₂ copolymer, diallyl amine salt-SO₂ copolymer, dimethyl diallyl ammonium chloride polymer, polymer of allyl amine, dialkyl aminoethyl (meth)acrylate quaternary salt polymer, and acryl-amide-diallyl amine salt copolymer.

In particular, vapor phase silica of which specific surface area by BET method is 200 m²/g or more is preferred. By containing vapor phase silica, a porous structure is obtained, and the ink absorbing performance is improved, and by the specific surface area of 200 m²/g or more, the ink absorbing property is improved, and drying speed and ink blurring resistance are improved, and the image quality and print density are enhanced.

BET method is a one of measuring methods of surface area of powder by vapor phase adsorption method, and it is a method of determining the total surface area of 1 g of sample, that is, the specific surface area by adsorption isotherm. Usually, nitrogen gas is used as adsorbing gas, and the adsorption amount is measured from the change in pressure or volume of the adsorption gas. Brauner, Emmett, Teller formula (BET formula) is known as a formula for expressing isotherm of multimolecular adsorption, and the adsorption amount is determined by this formula, and is multiplied by the surface occupied by one molecule of adsorption in the surface, and the surface area is determined.

(Water-Soluble Resin)

The ink-receiving layer coating solution contains a water-soluble resin. The water-soluble resin includes, for example, polyvinyl alcohol (PVA), polyvinyl acetal, cellulose-based resin [methyl cellulose (MC), ethyl cellulose (EC), hydroxy ethyl cellulose (HEC), carboxy methyl cellulose (CMC), etc.], kitins, chitosans, starch; resins having ether bond, such as polyethylene oxide (PEO), polypropylene oxide (PPO), polyethylene glycol (PEG), and polyvinyl ether (PVE); resins having amide group or amide bond, such as polyacrylic amide (PAAM), polyvinyl pyrrolidone (PVP), and polyacrylate having carboxyl group as dissociative group, maleic acid resin, arginate, and gelatins. They may be used either alone or in combination of two or more kinds.

In particular, polyvinyl alcohol is preferred, and the polyvinyl alcohol can be used in combination with other water-soluble resins. The content of polyvinyl alcohol in the total mass of water-soluble resin used in combination is preferably 90 mass % or more, or more preferably 95 mass % or more.

The polyvinyl alcohol includes, aside from polyvinyl alcohol (PVA), cation denatured polyvinyl alcohol, anion denatured polyvinyl alcohol, silanol denatured polyvinyl alcohol, and other polyvinyl alcohol derivatives. The polyvinyl alcohol may be used either alone or in combination of two or more kinds.

The polyvinyl alcohol (PVA) has a hydroxyl group in its structural unit, and this hydroxyl group and silanol group of silica fine particle surface form a hydrogen bond, and it is likely to form a three-dimensional reticular structure having secondary particle of silica fine particle as chain unit. By forming of this three-dimensional reticular structure, it is estimated that an ink-receiving layer of porous structure of high voids is formed.

The ink-receiving layer formed in the porous structure is quick to absorb ink by the capillary phenomenon in the inkjet recording operation, and true round dots without blurring of ink can be formed.

The content of water-soluble resin (especially polyvinyl alcohol) is preferably 9 to 40 mass %, more preferably 12 to 33 mass %, in the total mass of solid content of the layer when the ink-receiving layer is formed, from the viewpoint of preventing decline in strength of film or cracks in drying due to insufficient content, or preventing clogging of gaps with resin or drop of ink absorbing property by decline in void ratio due to excessive content.

Number-average polymerization degree of polyvinyl alcohol (PVA) is preferably 1800 or more, or more preferably 2000 or more, from the viewpoint of prevention of cracking. From the viewpoint of transparency and viscosity of coating solution for forming the ink-receiving layer, the saponification degree of PVA is preferably 88% or more, or more preferably 95% or more.

—Blending Ratio of Inorganic Fine Particles and Water-Soluble Resin—

The blending ratio of inorganic fine particles (i) and water-soluble resin (p) [PB ratio (i:p); mass of inorganic fine particles in 1 part by mass of water-soluble resin] is very important, having large effects on film structure when a layer is formed. That is, as the PB value increases, the porosity, pore volume, and surface area (per unit mass) become larger. Specifically, the PB ratio is preferred to be 1.5:1 to 10:1, from the viewpoint of preventing lowering of film strength or cracking when drying due to excessively large PB ratio, or preventing clogging of pores with resin, decline in void ratio, and decline in ink absorption due to excessively small PB ratio.

When the inkjet recording medium passes the conveying-based of inkjet printer, stress may be applied, and sufficient film strength is required in the ink-receiving layer. When cutting into sheets, to prevent cracking of ink-receiving layer, sufficient film strength is needed in the ink-receiving layer. From such points of view, the PB is preferred to be 5:1 or less, or more preferably 2:1 or more from the viewpoint of assuring high speed ink absorption by inkjet printer.

For example, vapor phase silica of which average primary particle diameter is 20 nm or less and water-soluble resin are completely dispersed in aqueous solution at PB ratio of 2:1 to 5:1, and this coating solution is applied on a support, and the coating layer is dried, and a three-dimensional reticular structure is formed in the chain unit of secondary particles of silica fine particles, and thereby a light permeable porous film of average pore size of 30 nm or less, void ratio of 50% to 80%, pore specific volume of 0.5 ml/g or more, and specific surface area of 100 m²/g or more can be easily formed.

(Crosslinking Agent)

Crosslinking agent may be contained in the ink-receiving layer coating solution, or may be further contained in the basic solution.

The crosslinking agent may crosslink the water-soluble resin, and by containing the crosslinking agent, a porous layer cured by crosslinking reaction of the crosslinking agent and water-soluble resin can be formed.

For crosslinking of water-soluble resin, especially, polyvinyl alcohol resin, a boron compound is preferred. Examples of boron compound include borax, boric acid, borate (e.g. orthoborate, InBO₃, ScBO₃, YBO₃, LaBO₃, Mg₃(BO₃)₂, CO₃(BO₃)₂), diborate (e.g. Mg₂B₂O₅, CO₂B₂O₅), metaborate (e.g. LiBO₂, Ca(BO₂)₂, NaBO₂, KBO₂), tetraborate (e.g. Na₂B₄O₇.10H₂O), and pentaborate (e.g. KB₅O₈.4H₂O, Ca₂B₆O₁₁±7H₂O, CsB₅O₅). In particular, borax, boric acid, and borate preferred because the crosslinking reaction can be induced quickly, and especially boric acid is preferred.

Aside from boron compound, the following compounds may be also used. Examples are aldehyde-based compounds such as formaldehyde, glyoxal, and glutar aldehyde; ketone compounds such as diacetyl and cyclopentane dion; active halogen compounds such as bis (chloroethyl urea)-2-hydroxy-4,6-dichloro-1,3,5-triazine, and 2,4-dichloro-6-S-triazine sodium salt); active vinyl compounds such as divinyl sulfonic acid, 1,3-vinylsulfonyl-2-propanol, N,N′-ethylene bis(vinyl sulfonyl acetamide), and 1,3,5-triacryloyl-hexahydro-S-triazine; N-methylol compounds such as dimethylol urea and methylol dimethyl hydantoin; melamine resins (e.g. methylol melamine, alkylated methylol melamine); epoxy resins;

isocyanate-based compounds such as 1,6-hexamethylene diisocyanate; aziridine-based compounds disclosed in U.S. Pat. No. 3,017,280 and U.S. Pat. No. 2,983,611; carboxyimide-based compounds disclosed in U.S. Pat. No. 3,100,704; epoxy-based compounds such as glycerol triglycidyl ether; ethylene imino-based compounds such as 1,6-hexamethylene-N,N′-bisethylene urea; halogenated carboxy aldehyde-based compounds such as mucochloric acid and mucophenoxy chloric acid; dioxane-based compounds such as 2,3-dihydroxy dioxane; compounds containing metal such as titanium lactate, aluminum sulfate, chrome alum, potassium alum, zirconyl acetate, and chromium acetate; polyamine compounds such as tetraethylene pentamine; hydrazide compounds such as hydrazide adipate; and low molecule or polymer containing two or more oxazoline groups. These crosslinking agents may be used either alone or in combination of two or more kinds.

The crosslinking agent may be added in the ink-receiving layer coating solution and/or coating layer for forming adjacent layer of ink-receiving layer, when applying the ink-receiving layer coating solution, or the crosslinking agent may be preliminarily contained in the coating solution to be applied on the support, on which the ink-receiving layer coating solution is applied, or the crosslinking agent may be supplied in the ink-receiving layer by overcoating with basic solution after applying and drying the ink-receiving layer coating solution either containing or not containing the crosslinking agent.

For example, the crosslinking agent may be added preferably in the following manner. An example of boron compound is explained. The ink-receiving layer is a layer formed by crosslinking and curing the coating layer on which the ink-receiving layer coating solution (first solution) is applied, and the crosslinking and curing process is executed by alkali treatment with basic gas or by applying the basic solution on the coating layer, in the midst of drying of coating layer formed by applying the first solution, and before the coating layer shows falling drying rate, but as the crosslinking agent, the boron compound may be contained in either the first solution or the second solution, or in both solutions. When the ink-receiving layer is formed in two or more layers, two or more coating solutions can be applied in multiple layers, and the second solution may be applied on the multiple layers.

The content of crosslinking agent is preferably 1 to 50 mass %, or more preferably 5 to 40 mass % in the total mass of water-soluble resin.

(Surface Active Agent)

Preferably, a surface active agent is contained in the ink-receiving layer coating solution. The surface active agent includes any one of cationic, anionic, nonionic, amphoteric, fluorine, or silicone-based surface active agents. These surface active agents may be used either alone or in combination of two or more kinds.

Examples of nonionic-based surface active agent include polyoxy alkylene alkyl ether and polyoxy alkylene phenyl ethers (e.g. diethylene glycol monoethyl ether, diethylene glycol diethyl ether, polyoxy ethylene lauryl ether, polyoxy ethylene stearyl ether, polyoxy ethylene nonyl phenyl ether), oxyethylene-oxypropylene block copolymer, sorbitan fatty acid esters (e.g. sorbitan monolaurate, sorbitan mono-olate, sorbitan triol), polyoxy ethylene sorbitan fatty acid esters (e.g. polyoxy ethylene sorbitan monolaurate, polyoxy ethylene sorbitan mono-olate, polyoxy ethylene sorbitan triol), polyoxy ethylene sorbitol fatty acid esters (e.g. tetraoleic polyoxy ethylene sorbit), glycerin fatty acid esters (e.g. glycerol mono-olate), polyoxy ethylene glycerin fatty acid esters (e.g. monostearic polyoxy ethylene glycerin, mono-oleic polyoxy ethylene glycerin), polyoxy ethylene fatty acid esters (e.g. polyethylene glycol monolaurate, polyethylene glycol mono-olate), polyoxy ethylene alkyl amine, and acetylene glycols (e.g. 2,4,7,9-tetramethyl-5-desin-4,7-diol, ethylene oxide adduct of the diol, and propylene oxide adduct), and polyoxy alkylene alkyl ethers are particularly preferred. The nonionic surface active agent may be contained in the ink-receiving layer coating solution.

Examples of amphoteric surface active agent include an amino acid type, carboxy ammonium betaine type, sulfone ammonium betaine type, ammonium sulfate ester betaine type, and imidazolium betaine type, and particularly preferred examples are disclosed in the publications: U.S. Pat. No. 3,843,368, JP-A No. 59-49535, No. 63-236546, No. 5-303205, No. 8-262742, and No. 10-282619. As the amphoteric surface active agent, an amino acid type amphoteric surface active agent is preferred, and examples of amino acid type amphoteric surface active agent are derived from amino acids (glycine, glutamic acid, histidinic acid or the like) as disclosed in JP-A No. 5-303205, and amino acylic acid introducing long-chain acyl group and its salt are known.

Examples of anionic surface active agent include fatty acid salt (e.g. sodium stearate, potassium oleate), alkyl sulfate ester salt (e.g. sodium lauryl sulfate, triethanol amine lauryl sulfate), sulfonate (e.g. sodium dodecyl benzene sulfonate), alkyl sulfosuccinate (e.g. sodium dioctyl sulfosuccinate), alkyl diphenyl ether disulfonate, and alkyl phosphate.

Examples of cationic surface active agent include alkyl amine salt, quaternary ammonium salt, pyridinium salt, and imidazolium salt.

Examples of fluorine-based surface active agent include compounds derived by way of an intermediate having perfluoroalkyl group by a method of electrolytic fluorination, teromerization, or oligomerization. Preferred examples are perfluoroalkyl sulfonate, perfluoroalkyl carbonate, a perfluoroalkyl ethylene oxide adduct, perfluoroalkyl tolyl alkyl ammonium salt, oligomer containing perfluoroalkyl group, and ester perfluoroalkyl phosphate.

The silicone-based surface active agent is preferably a silicone oil denatured by organic group, including a structure having the side chain of siloxane structure denatured by organic group, a structure denatured at both ends, and a structure denatured at one end. Organic group denaturing includes amino denaturing, polyether denaturing, epoxy denaturing, carboxy denaturing, carbinol denaturing, alkyl denaturing, aralkyl denaturing, phenol denaturing, and fluorine denaturing.

Content of surface active agent in ink-receiving layer coating solution is preferably 0.001 to 2.0%, or more preferably 0.01 to 1.0%.

The inkjet recording medium thus manufactured in the manufacturing method of inkjet recording medium of the invention is composed of at least one layer of ink-receiving layer formed on a support, and this ink-receiving layer contains water-soluble resin and crosslinking agent, and may further contain other components as required such as mordant.

—Support—

The support usable in the invention is either a transparent support made of plastic or other transparent material, or an opaque support made of paper or other opaque material. For making the best of transparency of ink-receiving layer, it is preferred to use transparent support or opaque support having high glossiness. The support may be also made of read-only optical disk such as CD-ROM or DVD-ROM, recordable optical disk such as CD-R or DVD-R, or programmable optical disk, and the ink-receiving layer can be provided at both sides of the label.

Usable materials for transparent support are transparent materials capable of withstanding radiant heat used in OHP or backlight display. Examples include polyesters such as polyethylene terephthalate (PET); polysulfone, polyphenylene oxide, polyimide, polycarbonate, and polyamide. In particular, polyesters are preferred, and polyethylene terephthalate is especially preferred.

Thickness of transparent support is not particularly limited, but is preferred to be 50 to 200 μm from the viewpoint of ease of handling.

Opaque support of high glossiness is preferred to have glossiness of 40% or more on the surface forming the ink-receiving layer. The glossiness is measured by a method of JIS P-8142 (Testing method for 75 degrees specular glossiness of paper and board). Examples of support are given below.

Paper support of high glossiness, such as art paper, coat paper, cast coat paper, and baryta paper used in support for silver salt photograph; polyesters such as polyethylene terephthalate (PET), cellulose esters such as nitrocellulose, cellulose acetate, and cellulose acetate butylate, glossy film made opaque (or having the surface calendered) by containing white pigment in plastic films such as polysulfone, polyphenylene oxide, polyimide, polycarbonate, and polyamide; or support bodies having coating film layer of polyolefin either containing or not containing white pigment on the surface of glossy film having paper support, transparent support or white pigment. Other preferred example is a foamed polyester film containing white pigment (for example, foamed PET containing polyolefin fine particles, and having voids formed by drawing).

Thickness of opaque support is not particularly limited, but is preferred to be 50 to 300 μm from the viewpoint of ease of handling.

On the surface of support, corona discharge treatment, glow discharge treatment, flame treatment or ultraviolet irradiation treatment may be applied for the purpose of enhancing the wettability or adhesion.

Material paper used for paper support is described in detail.

Paper is mainly made of wood pulp, and in addition to wood pulp, as required, synthetic pulp such as polypropylene or synthetic fiber such as nylon or polyester may be added in paper making process. The wood pulp includes LBKP, LBSP, NBKP, NBSP, LDP, NDP, LUKP, or NUKP, and it is preferred to use higher contents of LBKP, NBSP, LBSP, NDP, LDP higher in contents of short fibers. The ratio of LBSP and/or LDP is preferably 10 mass % or more and 70 mass % or less. The pulp is preferably chemical pulp low in impurities (sulfate pulp or sulfite pulp), and pulp enhanced in whiteness by bleaching process is also useful.

The paper material may also contain sizing agent such as higher fatty acid and alkyl ketene dimer, white pigment such as calcium carbonate, talc, and titanium oxide, paper strength intensifier such as starch, polyacrylamide, and polyvinyl alcohol, fluorescent bleach, moisture retainer such as polyethylene glycol, dispersant, softening agent such as quaternary ammonium, and others properly.

Water filtering degree of pulp used in paper making is preferably 200 to 500 ml in CSF standard, and fiber length after beating is preferably 30 to 70% in the sum of 24-mesh residue mass % and 42-mesh residue mass % specified in JIS P-8207. Meanwhile, 4-mesh residue mass % is preferred to be 20 mass % or less. The stock paper weight is preferred to be 30 to 250 g, particularly preferably 50 to 200 g. Paper thickness is preferably 40 to 250 μm. Stock paper may be enhanced in glossiness by calendering during or after paper making process. Paper density is generally 0.7 to 1.2 g/m² (JIS P-8118). Paper rigidity is preferably 20 to 200 g in the condition specified in JIS P-8143.

Surface sizing agent may be applied on the stock paper surface, and the surface sizing agent may be same as the sizing agent applicable to stock paper. The pH of stock paper is preferred to be 5 to 9 as measured by hot water extraction method specified by JIS P-8113.

Surface of both sides of stock paper may be coated generally with polyethylene. Polyethylene is mainly low density polyethylene (LDPE) and/or high destiny polyethylene (HDPE), but other LLDPE or polypropylene may be partially used.

In particular, the polyethylene layer at the forming side of ink-receiving layer is preferred to be improved in opacity, whiteness and hue, by adding rutyl or anatase type titanium oxide, fluorescent whiteness intensifier, or ultramarine blue in the polyethylene, as widely employed in photographic printing paper. The content of titanium oxide is preferably about 3 to 20 mass % in polyethylene, or more preferably 4 to 13 mass %. Thickness of polyethylene layer is not particularly limited, but is preferably about 10 to 50 μm each on both of front surface and back surface layers. An undercoating layer may be applied on the polyethylene layer in order to enhance adhesion to the ink-receiving layer. The undercoating layer is preferably water-based polyester, gelatin, or PVA. Thickness of undercoating layer is preferably 0.01 to 5 μm.

A polyethylene covered paper can be used as a glossy paper, or a paper on which a mat surface or a silk-like surface like that obtained in a conventional photographic paper by performing so-called embossing treatment when polyethylene is melt-extruded on a raw paper surface to perform coating, can be also used.

Mordant and other components are described below.

[Mordant]

In the invention, it is preferred to contain mordant in the ink-receiving layer in order to improve water resistance of formed image and blurring resistance over time. The mordant includes both organic mordant such as cationic polymer (cationic mordant) and inorganic mordant such as water-soluble metal compound. In particular, water-soluble polyhydric metal salt is preferred.

Examples of water-soluble polyhydric metal salt compound include water-soluble salt of metal selected from calcium, barium, manganese, copper, cobalt, nickel, aluminum, iron, zinc, zirconium, chromium, magnesium, tungsten, and molybdenum.

Specific examples are calcium acetate, calcium chloride, calcium formate, calcium sulfate, barium acetate, barium sulfate, barium phosphate, manganese chloride, manganese acetate, manganese dihydrate formate, manganese ammonium hexahydrate sulfate, cupric chloride, ammonium copper (II) dihydrate chloride, copper sulfate, cobalt chloride, cobalt thiocyanate, cobalt sulfate, nickel hexahydrate sulfate, nickel hexahydrate chloride, nickel tetrahydrate acetate, nickel ammonium hexahydrate sulfate, amide nickel tetrahydrate sulfate, aluminum sulfate, sulfurous aluminum, aluminum thiosulfate, polyaluminum chloride, aluminum nonahydrate nitrate, aluminum hexahydrate chloride, ferrous bromide, ferrous chloride, ferric chloride, ferrous sulfate, ferric sulfate, zinc bromide, zinc chloride, zinc hexahydrate nitrate, zinc sulfate, zirconium acetate, zirconium chloride, zirconium octahydrate chloride oxide, hydroxy zirconium chloride, chromium acetate, chromium sulfate, magnesium sulfate, magnesium hexahydrate chloride, magnesium nonahydrate citrate, sodium phosphotungstate, sodium tungsten citrate, n hydrate 12 tungstophosphate, 26 hydrate 12 tungstophosphate, molybdenum chloride, and n hydrate 12 molybdophosophate.

The water-soluble polyhydric metal compound is particularly preferred to be at least one selected from water-soluble aluminum compound, zirconium compound, and titanium compound.

The aluminum compound is, for example, inorganic salt such as aluminum chloride or its hydrate, aluminum sulfate or its hydrate, and aluminum alum. Other examples include basic aluminum polyhydroxide compound as inorganic cation polymer containing aluminum. In particular, basic aluminum polyhydroxide compound is preferred.

The basic aluminum polyhydroxide compound is a water-soluble polyhydroxide aluminum having primary components expressed in formula 1, 2, or 3, and stably containing basic and high molecular polynuclear condensation ions, such as [Al₆(OH)₁₅]³⁺, [Al₈(OH)₂₀]⁴⁺, [Al₁₃(OH)₃₄]⁵⁺, and [Al₂₁(OH)₆₀]³⁺.

[Al₂(OH)ₙCl₆₋ₙ]ₘ formula 1

[Al(OH)₃]ₙAlCl₃ formula 2

Alₙ(OH)ₘCl₍₃ₙ₋ₘ₎(0<m<3n) formula 3

These compounds are commercially available, in the name of polyaluminum chloride (PAC) from Tagi Chemical Co., Ltd., as water treatment agent, in the name of polyaluminum hydroxide (Paho) from Asada Chemical Industry Co., Ltd., in the name of Purachem WT from Rikengreen Co., Ltd., or in the name of Alfine 83, Tiepack, Alfine 33 from Taimei Chemicals Co., Ltd., and similar compounds for similar purposes are easily available from various manufacturers in various grades. In the invention, these commercial products may be used directly, but the pH may be adjusted properly if excessively low.

Zirconium compound used in the invention is not particularly limited, and various compounds may be used. Examples include zirconyl acetate, zirconium chloride, oxyzirconium chloride, hydroxy zirconium chloride, zirconium nitrate, basic zirconium carbonate, zirconium hydroxide, zirconium carbonate ammonium zirconium carbonate potassium, zirconium sulfate, and zirconium fluoride. Especially zirconyl acetate is preferred.

Titanium compound is not particularly limited, and various compounds may be used, and, for example, titanium chloride or titanium sulfate may be used.

Some of these compounds may be excessively low in pH, and the pH should be adjusted properly. In the invention, a water-soluble compound is defined to be soluble by 1 mass % or more in water at ordinary temperature and pressure.

In the invention, the content of water-soluble polyhydric metal salt compound in the ink-receiving layer is 0.1 to 10 mass % in fine particles, preferably 1 to 5 mass %.

The water-soluble polyhydric metal salt compound may be used alone, but preferably two or more kinds may be combined.

By containing the mordant at least on the upper layer of ink-receiving layer, an interaction occurs with the liquid ink for inkjet containing anionic dye as color material, and the color material is stabilized, and water resistance and blurring resistance over time may be further improved.

The cationic mordant is preferably a polymer mordant having primary to tertiary amino group or quaternary ammonium salt group as cationic group, and cationic non-polymer mordant may be also used.

The polymer mordant may be either single polymer of monomer (mordant monomer) having primary to tertiary amino group or quaternary ammonium salt group, or copolymer or condensation polymer of the mordant monomer with other monomer (non-mordant monomer). These polymer mordants may be used as water-soluble polymer or as water dispersing latex particles.

Examples of mordant monomer quaternary compounds of methyl chloride, ethyl chloride, methyl bromide, ethyl bromide, methyl iodide, or ethyl iodide, or sulfonates, alkyl sulfonates, acetates or alkylcarbonates of them having their anions substituted, including trimethyl-p-vinyl benzyl ammonium chloride, trimethyl-m-vinyl benzyl ammonium chloride, triethyl-p-vinyl benzyl ammonium chloride, triethyl-m-vinyl benzyl ammonium chloride, N,N-dimethyl-N-ethyl-N-p-vinyl benzyl ammonium chloride, N,N-diethyl-N-methyl-N-p-vinyl benzyl ammonium chloride, N,N-dimethyl-N-n-propyl-N-p-vinyl benzyl ammonium chloride, N,N-dimethyl-N-n-octyl-N-p-vinyl benzyl ammonium chloride, N,N-dimethyl-N-benzyl-N-p-vinyl benzyl ammonium chloride, N,N-diethyl-N-benzyl-N-p-vinyl benzyl ammonium chloride, N,N-dimethyl-N-(4-methyl)benzyl-N-p-vinyl benzyl ammonium chloride, N,N-dimethyl-N-phenyl-N-p-vinyl benzyl ammonium chloride;

trimethyl-p-vinyl benzyl ammonium chloride, trimethyl-m-vinyl benzyl ammonium chloride, trimethyl-p-vinyl benzyl ammonium sulfonate, trimethyl-m-vinyl benzyl ammonium sulfonate, trimethyl-p-vinyl benzyl ammonium acetate, trimethyl-m-vinyl benzyl ammonium acetate, N,N,N-triethyl-N-2(4-vinyl phenyl)ethyl ammonium chloride, N,N,N-triethyl-N-2(3-vinyl phenyl)ethyl ammonium chloride, N,N-diethyl-N-methyl-N-2(4-vinyl phenyl)ethyl ammonium chloride, N,N-diethyl-N-methyl-N-2(4-vinyl phenyl)ethyl ammonium acetate;

N,N-dimethyl aminoethyl (meth)acrylate, N,N-diethyl aminoethyl (meth)acrylate, N,N-dimethyl aminopropyl (meth)acrylate, N,N-diethyl aminopropyl (meth)acrylate, N,N-dimethyl aminoethyl (meth) acrylamide, N,N-diethyl aminoethyl (meth) acrylamide, N,N-dimethyl aminopropyl (meth) acrylamide, and N,N-diethyl aminopropyl (meth) acrylamide.

Specific compounds include monomethyl diallyl ammonium chloride, trimethyl-2-(methacryloyl oxy) ethyl ammonium chloride, triethyl-2-(methacryloyl oxy) ethyl ammonium chloride, trimethyl-2-(acryloyl oxy) ethyl ammonium chloride, triethyl-2-(acryloyl oxy) ethyl ammonium chloride, trimethyl-3-(methacryloyl oxy) propyl ammonium chloride, triethyl-3-(methacryloyl oxy) propyl ammonium chloride, trimethyl-2-(methacryloyl amino) ethyl ammonium chloride, triethyl-2-(methacryloyl amino) ethyl ammonium chloride, trimethyl-2-(methacryloyl amino) ethylene ammonium chloride, triethyl-2-(methacryloyl amino) ethylene ammonium chloride, trimethyl-3-(methacryloyl amino) propyl ammonium chloride, triethyl-3-(methacryloyl amino) propyl ammonium chloride, trimethyl-3-(acryloyl amino) propyl ammonium chloride, triethyl-3-(acryloyl amino) propyl ammonium chloride;

N,N-dimethyl-N-ethyl-2-(methacryloyl oxy) ethyl ammonium chloride, N,N-diethyl-N-ethyl-2-(methacryloyl oxy) ethyl ammonium chloride, N,N-dimethyl-N-ethyl-2-(acryloyl oxy) propyl ammonium chloride, trimethyl-2-(methacryloyl oxy) ethyl ammonium bromide, trimethyl-3-(acryloyl oxy) propyl ammonium bromide, trimethyl-2-(methacryloyl oxy) ethyl ammonium sulfonate, and trimethyl-3-(acryloyl oxy) propyl ammonium acetate.

Other copolymerizable monomers include N-vinyl imidazole, and N-vinyl-2-methyl imidazole.

Allylamine, diallylamine, and their derivatives and salts may be also used. Examples of such compounds include allylamine, allylamine hydrochloride, allylamine acetate, allylamine sulfate, diallylamine, diallylamine hydrochloride, diallylamine acetate, diallylamine sulfate, diallyl methylamine and its salt (salt including hydrochloride, acetate, sulfate), diallyl ethylamine and its salt (salt including hydrochloride, acetate, sulfate), and diallyl dimethyl ammonium salt (pair anion of the salt including chloride, acetic ion, sulfuric ion). These allylamine and diallylamine derivatives are inferior in polymerization property in the form of amine, and are generally polymerized in the form of salt, and desalted as required.

Using polymerization unit of N-vinyl acetamide or N-vinyl formamide, vinyl amine unit is formed by hydrolysis after polymerization, may be further formed into salt and used.

The non-mordant monomer is a monomer not containing basic or cationic portion such as primary to tertiary amino group or its salt, or quaternary ammonium base, not showing interaction with dye in the ink for inkjet, or substantially small in interaction.

Examples of non-mordant monomer include alkyl ester of (meth)acrylate; cycloalkyl ester of (meth)acrylate such as cyclohexyl (meth)acrylate; aryl ester (meth)acrylate such as phenyl (meth)acrylate; aralkyl ester such as benzyl (meth)acrylate; aromatic vinyls such as styrene, vinyl toluene, and α-methyl styrene; vinyl esters such as vinyl acetate, vinyl propionate, and vinyl varsatate; allyl esters such as allyl acetate; monomers containing halogen such as vinylidene chloride and vinyl chloride; cyanated vinyl such as (meth)acrylonitrile; and olefins such as ethylene and propylene.

As alkyl ester (meth)acrylate, alkyl ester (meth)acrylate having 1 to 18 carbon atoms in the alkyl portion is preferred, and specific examples include methyl (meth)acrylate, ethyl (meth)acrylate, propyl (meth)acrylate, isopropyl (meth)acrylate, n-butyl (meth)acrylate, isobutyl (meth)acrylate, t-butyl (meth)acrylate, hexyl (meth)acrylate, octyl (meth)acrylate, 2-ethyl hexyl (meth)acrylate, lauryl (meth)acrylate, and stearyl (meth)acrylate. Among these, preferred examples are methyl acrylate, ethyl acrylate, methyl methacrylate, ethyl methacrylate, and hydroxy ethyl methacrylate. The non-mordant monomers may be used either alone or in combination of two or more kinds.

The polymer mordant further includes polydiallyl methyl ammonium chloride, polymethacryloyl oxy ethyl-β-hydroxy ethyl dimethyl ammonium chloride, polyethylenimine, polyallyl amine and its denatured compound, polyallyl amine hydrochloride, polyamide-polyamine resin, cationated starch, dicyan diamide formalin condensate, dimethyl-2-hydroxy propyl ammonium salt polymer, polyamidine, polyvinyl amine, or cationic acryl emulsion (trade name Aquabrid Series ASi-781, ASi-784, ASi-578, ASi-903 manufactured by Daicel Chemical Industries, Ltd.) of acryl silicon latex disclosed in JP-A No. 10-264511, No. 2000-43409, No. 2000-343811, and No. 2002-120452.

The molecular weight of mordant is preferred to be weight-average molecular weight of 2000 to 300000. When the molecular weight in this range, and water resistance and blurring resistance over time can be further improved.

—Other Components—

The ink-receiving layer may further contain the following components as required.

To suppress deterioration of color material, the ink-receiving layer may contain various ultraviolet absorbents, surface active agents, antioxidants, singlet enzyme quencher, and other anti-fading agent.

The ultrasonic absorbent includes cinnamic acid derivative, benzophenone derivative, and benzotriazolyl phenol derivative. Examples are α-cyano-phenyl cinnamic butyl, o-benzotriazol phenol, o-benzotriazol-p-chlorophenol, o-benzotriazole-2,4-di-t-butyl phenol, and o-benzotriazole-2,4-di-t-octyl phenol. Hindered phenol compound is also usable as ultraviolet absorbent, and specifically a phenol derivative having at least one position or more of position 2 and position 6 substituted by branch alkyl group is preferred.

Further, benzotriazole ultraviolet absorbent, salicylic acid ultraviolet absorbent, cyano acrylate ultraviolet absorbent, and oxalic acid anilide ultraviolet absorbent may be also used. Examples are disclosed in JP-A No. 47-10537, No. 58-111942, No. 58-212844, No. 59-19945, No. 59-46646, No. 59-109055, No. 63-53544, Japanese Patent Application Publication (JP-B) No. 36-10466, No. 42-26187, No. 48-30492, No. 48-31255, No. 48-41572, No. 48-54965, No. 50-10726, U.S. Pat. No. 2,719,086, No. 3,707,375, No. 3,754,919, and No. 4,220,711.

Optical brightener may be also used as ultraviolet absorbent, and, for example, coumarine-based Optical brightener may be used. Specific examples are disclosed in JP-B No. 45-4699 and No. 54-5324.

Examples of antioxidant are disclosed in European Patent Laid-Open No. 223739, No. 309401, No. 309402, No. 310551, No. 310552, No. 459-416, German Patent Laid-Open No. 3435443, JP-A No. 54-48535, No. 60-107384, No. 60-107383, No. 60-125470, No. 60-125471, No. 60-125472, No. 60-287485, No. 60-287486, No. 60-287487, No. 60-287488, No. 61-160287, No. 61-185483, No. 61-211079, No. 62-146678, No. 62-146680, No. 62-146679, No. 62-282885, No. 62-262047, No. 63-051174, No. 63-89877, No. 63-88380, No. 66-88381, No. 63-113536,

No. 63-163351, No. 63-203372, No. 63-224989, No. 63-251282, No. 63-267594, No. 63-182484, No. 1-239282, No. 2-262654, No. 2-71262, No. 3-121449, No. 4-291685, No. 4-291684, No. 5-61166, No. 5-119449, No. 5-188687, No. 5-188686, No. 5-110490, No. 5-1108437, No. 5-170361, JP-B No. 48-43295, No. 48-33212, U.S. Pat. No. 4,814,262, and No. 4,980,275.

Specific examples include 6-ethoxy-1-phenyl-2,2,4-trimethyl-1,2-dihydroquinoline, 6-ethoxy-1-octyl-2,2,4-trimethyl-1,2-dihydroquinoline, 6-ethoxy-1-phenyl-2,2,4-trimethyl-1,2,3,4-terahydroquinoline, 6-ethoxy-1-octyl-2,2,4-trimethyl-1,2,3,4-terahydroquinoline, nickel cyclohexanate, 2,2-bis (4-hydroxyphenyl) propane, 1,1-bis(4-hydroxyphenyl)-2-ethyl hexane, 2-methyl-4-methoxy-diphenylamine, and 1-methyl-2-phenyl indole.

These anti-fading agents may be used either alone or in combination of two or more kinds. The anti-fading agent may be prepared in water-soluble form, disperse form, or emulsion form, or may be contained in microcapsule. The content of anti-fading agent is preferably 0.01 to 10 mass % in the ink-receiving layer coating solution.

The ink-receiving layer may further contain various inorganic acids for enhancing the dispersion property of inorganic fine particles, or acid or alkali for adjusting the pH. Further, to suppress frictional charge or peeling charge of the surface, metal oxide fine particles having electron conductivity may be contained, or various mat agents may be added for the purpose of reducing surface frictional characteristics.

<Inkjet Recording Medium>

The inkjet recording medium of the invention is manufactured by the manufacturing method of inkjet recording medium of the invention. Hence it is an inkjet recording medium high in glossiness.

In the invention, the ink-receiving layer may contain an acid. By adding an acid, the surface pH of the ink-receiving layer is adjusted to 3 to 6, or preferably 3 to 5. As a result, the resistance of white portion to yellowing is enhanced. The surface pH is measured by method A (coating method) of surface pH measuring method specified by Japan Technical Association of Paper Pulp Industries (J.TAPPI). By using “format MPC” of paper pH measuring set manufactured by Kyoritu Riken conforming to method A, the pH can be measured.

Specific examples of acid include formic acid, acetic acid, glycolic acid, oxalic acid, propionic acid, malonic acid, succinic acid, adipinic aid, maleic acid, malic acid, tartaric acid, citric acid, benzoic acid, phthalic acid, isophthalic acid, glutaric acid, gluconic acid, lactic acid, aspartic acid, glutamic acid, salicylic acid, salicylic acid metal salt (salt of Zn, Al, Ca, Mg), methane sulfonic acid, itaconic acid, benzene sulfonic acid, toluene sulfonic acid, trifluoromethane sulfonic acid, styrene sulfonic acid, trifluoroacetic acid, barbituric acid, acrylic acid, methacrylic acid, cinnamic acid, 4-hydroxy benzoic acid, amino benzoic acid, naphthalene disulfonic acid, hydroxybenzene sulfonic acid, toluene sulfinic acid, benzene sulfinic acid, sulfanylic acid, sulfaminic acid, α-resorcinic acid, β-resorcinic acid, y-resorcinic acid, gallic acid, fluoroglycine, sulfosalicylic acid, ascorbic acid, erysorbic acid, bisphenolic acid, hydrochloric acid, nitric acid, sulfuric acid, phosphoric acid, polyphosphoric acid, boric acid, and boronic acid.

These acids may be used in the form of metal salt (e.g. salt of sodium, potassium, calcium, cesium, zinc, copper, iron, aluminum, zirconium, lanthanum, yttrium, magnesium, strontium, cerium), or amine salt (e.g. ammonia, triethylamine, tributylamine, piperazine, 2-methyl piperazine, polyallylamine).

### EXAMPLES

Examples of the invention are described below, but the invention is not limited to these examples alone. In the examples, the inkjet recording sheet is manufactured as inkjet recording medium, and the “parts” or “%” unit in the examples are based on the mass standard unless otherwise specified.

### Example 1

### Fabrication of Support

50 parts of LBKKP made from acacia and 50 parts of LEKP made from aspen were beaten in 300 mL of Canadian freeness by disk refiner, and pulp slurry was prepared.

In the obtained pulp slurry, per pair pulp, 1.3% of cationic starch (CATO 304 L manufactured by Nippon NSC), 0.15% of anionic polyacrylamide (Polyacron ST-13 manufactured by Seiko Chemical), 0.29% of alkyl ketene dimer (Sizepine K manufactured by Arakawa Chemical industries, Ltd.), 0.29% of epoxy behenic amide, and 0.32% of polyamide polyamine epichlorhydrin (Arafix 100 manufactured by Arakawa Chemical industries, Ltd.) were added, and then 0.12% of defoaming agent was added.

The prepared pulp slurry was processed by long mesh paper making machine, and the felt surface of the web was pressed and dried by using drum dryer cylinder and dryer canvas, in the condition of tensile force of dryer canvas of 1.6 kg/cm, and polyvinyl alcohol (KL-118 manufactured by Kuraray Corporation) was applied on both sides of stock paper by size press at 1 g/m², and the sides were calendered. The weight of the stock paper was 166 g/m², and stock paper (base paper) of thickness of 160 μm was obtained.

The wire side (back surface) of the base paper was processed by corona charge, and coated with high density polyethylene in a thickness of 25 μm by using melt extruding machine, and a thermoplastic resin layer of mat surface (hereinafter, thermoplastic resin layer is referred to as “back surface”). The thermoplastic resin layer of back surface is further processed by corona charge, and coated with antistatic agent by applying a disperse solution of aluminum oxide (Alumina Sol 100 manufactured by Nissan Chemical industries, Ltd.) and silicon dioxide (Snowtex O manufactured by Nissan Chemical industries, Ltd.) dispersed in water at a ratio of 1:2 by mass, to the dry mass of 0.2 g/m².

—Preparation of Inorganic Fine Particle Disperse Solution—

Vapor phase silica fine particles (1), ion exchange water (2), and polymer A (3) were mixed, and dispersed by using non-media dispersion machine (for example, ultrasonic dispersion machine manufactured by SMT), and the disperse solution was heated to 45° C., and held for 20 hours.

[Composition of Inorganic Fine Particle Disperse Solution]

(1) Vapor phase silica fine particles (inorganic fine particles, “AEROSIL 300SF75”, manufactured by Degussa Japan, average primary particle diameter 7 nm), 10.0 parts

(2) Ion exchange water, 52.6 parts

(3) Polymer A (silane coupling agent) 25% (ethanol dissolved solution), 4.0 parts

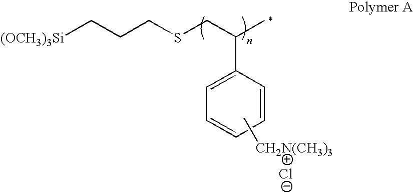

—Preparation of Ink-Receiving Layer Coating Solution (First Solution)—

Inorganic fine particle disperse solution (1), boric acid (2), polyvinyl alcohol dissolved solution (3), ethanol (4), and ion exchange water (5) were added at 30° C., and ink-receiving layer coating solution was prepared.

[Composition of Ink-Receiving Layer Coating Solution]

(1) Inorganic fine particle disperse solution, 66.7 parts

(2) Boric acid, 0.38 parts

(3) Polyvinyl alcohol (water-soluble resin) dissolved solution, 29.1 parts
PVA235 manufactured by Kuraray Corporation (saponification degree 88%, degree of polymerization 3500), 2.0 parts
Polyoxy ethylene lauryl ether (surface active agent, “Emulgen 109P”, 10% aqueous solution, HLB value 13.6 parts, manufactured by Kao Corporation), 0.75 parts
Diethylene glycol monobutyl ether (Butycenol 20P, manufactured by Kyowa Hakko Kogyo Co., Ltd.), 0.66 parts
Viscosity reducing agent “EDTA-DM (Sanko Co., Ltd.)”, 0.055 parts
Ion exchange water, 26.1 parts

(4) Ethanol, 2.6 parts

(5) Ion exchange water, 4.3 parts

[Composition of Basic Solution]

(1) Boric acid, 0.65 parts

(2) Zirconyl ammonium carbonate (Zircosol AC-7 (13% aqueous solution), manufactured by Daiichi Kigenso Kagaku Kogyo Co., Ltd.), 2.5 parts

(3) Ammonium carbonate (first grade, manufactured by Kanto Chemical Co., Inc.), 3.5 parts

(4) Ion exchange water, 63.3 parts

(5) Polyoxy ethylene lauryl ether (surface active agent, Emulgen 109P (2% aqueous solution) manufactured by Kao Corporation, HLB value 13.6), 30.0 parts

—Fabrication of Inkjet Recording Sheet—

The front surface side of the support was processed by corona discharge, and the coating solution was applied at a coating amount of 183 ml/m². Immediately before application, a polyaluminum chloride aqueous solution of 8 mass % (Alfine 83, manufactured by Taimei Chemicals Co., Ltd.) was mixed in the coating solution so that a coating amount thereof was 12.0 ml/m². Thereafter, alkali treatment was carried out by drying the coating layer to a solid content concentration of 20% at 80° C. (wind velocity of 3 to 8 m/sec) by a hot air dryer, in a drying zone at an ammonia gas concentration of 18 ppm. During this period, the coating layer exhibited a constant drying rate. Before exhibiting a falling drying rate, the coating layer was immersed in the basic solution having the above composition for 3 seconds, whereby 13 g/m² of the basic solution was deposited thereon, and the coating layer was further dried for 10 minutes at 80° C. (curing process). As a result, an inkjet recording medium having an ink-receiving layer with a dry film thickness of 32 μm provided thereon was fabricated.

The ammonia gas concentration was determined by measuring the ammonia gas concentration in the drying zone by using a gas measuring instrument GV-100 (manufactured by Gastech Corporation) and a gas detection tube No. 3 L (ammonia) (manufactured by Gastech Corporation).

### Examples 2 to 4, Comparative Example 1

Inkjet recording medium was fabricated in the same manner as in example 1, except that the ammonia gas concentration in alkali treatment was changed as shown in Table 1.

### Example 5, Comparative Example 2

Inkjet recording medium was fabricated in the same manner as in example 1, except that polymer A used in inorganic fine particle disperse solution was changed to

Sharol DC-902 (manufactured by Dai-ichi Kogyo Seiyaku Co., Ltd.), 0.87 parts and that the ammonia gas concentration in alkali treatment was changed as shown in Table 1.

[Evaluation]

Inkjet recording medium of examples 1 to 5, and inkjet recording medium of comparative examples 1 to 2 were evaluated as follows. Results are shown in Table 1.

(1) Measurement of Glossiness

Glossiness (60°) of inkjet recording medium was measuring by using digital bending glossimeter (manufactured by Suga Testing Machine). Results are shown in Table 1.

(2) Visual Evaluation of Glossiness

The surface of inkjet recording medium was visually observed, and the glossiness was evaluated according to the following criterion.

—Criterion—

A: glossy as fluorescent light looks glaring

B: slightly glossy but fluorescent light does not look glaring

C: not glossy and fluorescent light looks dim

TABLE 1

| | Ammonia | | |
|---|---|---|---|
| | concentration in | Glossiness | Visual evaluation of |
| | drying zone (ppm) | 60(°) | gloss |
| Example 1 | 18 | 86 | A |
| Example 2 | 10 | 62 | A |
| Example 3 | 28 | 101 | A |
| Example 4 | 5 | 47 | B |
| Example 5 | 18 | 57 | A |
| Comparative | 0 | 38 | C |
| Example 1 | | | |
| Comparative | 0 | 34 | C |
| Example 2 | | | |

As shown in Table 1, high glossiness was obtained in the inkjet recording medium of examples 1 to 5. It is conjectured that, in the drying process after application, due to passage through the drying zone with an ammonia gas atmosphere of 3 ppm or more, during the period from immediately after application until a falling drying rate is exhibited, the surface pH of the coating solution is raised, crosslinking reaction of PVA and boric acid is promoted on the surface of the coating solution, and only the surface is gelled, whereby it is estimated that a high glossiness is exhibited. In contrast, in comparative examples 1 and 2 where the ammonia concentration was 0 ppm, the surface was not gelled, and high glossiness was not observed.

Hence, the invention provides a manufacturing method of a recording medium that is excellent in glossiness, as well as an inkjet recording medium that is excellent in glossiness and a manufacturing method thereof.

All publications, patent applications, and technical standards mentioned in this specification are herein incorporated by reference to the same extent as if each individual publication, patent application, or technical standard was specifically and individually indicated to be incorporated by reference.

The disclosure of Japanese patent Application No. 2006-95929 is incorporated herein by reference in its entirety.

1. A manufacturing method of a recording medium, the method comprising drying a coating layer formed by applying a coating solution containing at least a water-soluble resin and a crosslinking agent, wherein the drying of coating layer includes performing alkali treatment on the coating layer surface by using a basic gas.

2. A manufacturing method of an inkjet recording medium, the method comprising: forming an ink-receiving layer by applying an ink-receiving layer coating solution containing at least a water-soluble resin and a crosslinking agent on a support; and performing alkali treatment on the coating layer surface by using a basic gas, during drying of the coating layer after forming the coating layer by applying the ink-receiving layer coating solution on the support.

3. The manufacturing method of an inkjet recording medium of claim 2, wherein the basic gas is ammonia gas.

4. The manufacturing method of an inkjet recording medium of claim 2, wherein the concentration of the basic gas during the drying is 3 ppm or more.

5. The manufacturing method of an inkjet recording medium of claim 2, wherein the alkali treatment by the basic gas is performed when the solid content concentration of the coating layer during the drying is 20 mass % or less, or while the coating layer is exhibiting a constant drying rate.

6. The manufacturing method of an inkjet recording medium of claim 2, wherein the ink-receiving layer coating solution further contains inorganic fine particles, and the inorganic fine particles are at least one selected from the group consisting of silica fine particles, colloidal silica, alumina fine particles, and puseudo-boehmite.

7. The manufacturing method of an inkjet recording medium of claim 2, wherein the water-soluble resin is a polyvinyl alcohol-based resin.

8. The manufacturing method of an inkjet recording medium of claim 2, wherein the crosslinking agent is a boron compound.

9. The manufacturing method of an inkjet recording medium of claim 2, wherein a basic solution of pH of 7.1 or more is applied on the coating layer after the alkali treatment and while the coating layer is exhibiting a constant drying rate.

10. An inkjet recording medium manufactured by the manufacturing method of an inkjet recording medium of claim 2.
